(19) United States
(12) Patent Application Publication
(10) Pub. No.: US 2011/0315313 A1
(43) Pub. Date: Dec. 29, 2011

(54) MANUFACTURING METHOD OF HERMETIC CONTAINER, AND MANUFACTURING METHOD OF IMAGE DISPLAYING APPARATUS

(75) Inventors: Kazuya Ishiwata, Yokosuka-shi (JP); Mamo Matsumoto, Kawasaki-shi (JP); Tomohiro Saito, Koza-gun (JP); Nobuhiro Ito, Yamato-shi (JP)

(73) Assignee: CANON KABUSHIKI KAISHA, Tokyo (JP)

(21) Appl. No.: 13/151,342

(22) Filed: Jun. 2, 2011

(30) Foreign Application Priority Data
Jun. 25, 2010 (JP) 2010-144893

(51) Int. Cl. B32B 37/16; B32B 37/10; B32B 37/12; B32B 37/06

(52) U.S. Cl. 156/272.2

(57) ABSTRACT

A manufacturing method of a highly-reliable hermetic container having both joining strength and airtightness is provided. Sealants of which a viscosity has a negative temperature coefficient and of which softening point is lower than that of each of first and second glass substrates are formed in a frame shape having a discontinuous portion on the first glass substrate, and the second glass substrate is disposed to face the first glass substrate so as to press the sealants formed thereon by contacting them. Local heating light is irradiated to form the discontinuous portion at a boundary between a region irradiated by the local heating light and a region not irradiated by the local heating light, and a portion adjacent to the discontinuous portion is heated and melted to close the discontinuous portion, whereby a continuous sealed portion between the first and second glass substrates is formed.

### BACKGROUND OF THE INVENTION

1. Field of the Invention

The present invention relates to a manufacturing method of a hermetic container, and a manufacturing method of an image displaying apparatus. In particular, the present invention relates to a manufacturing method of an image displaying apparatus of which the inside has been vacuumized and which is equipped with an electron-emitting device and a phosphor film.

2. Description of the Related Art

Conventionally, image displaying apparatuses of a flat panel type such as an organic LED display (OLED), a field emission display (FED), a plasma display panel (PDP), and the like have been well known. Each of the image displaying apparatuses is manufactured by hermetically sealing glass substrates facing each other and has a container in which the internal space is partitioned to an external space. To manufacture such a hermetic container, a spacing distance defining member, a local adhesive and the like are arranged between the facing glass substrates as necessary, a sealant is arranged in a frame shape to the peripheral portions of the glass substrates, and a heat sealing process is then performed. An example of the hermetic container manufactured in this way is illustrated in FIG. 7A. As a heating method of the sealant, a method whereby the whole glass substrates are baked by a furnace, and a method whereby the periphery of the sealant is selectively heated by local heating have been known. Generally, the local heating is more advantageous than whole heating from viewpoints of a time which is required to heat and cool, an energy which is required to heat, productivity, prevention of thermal deformation of a container, prevention of thermal deterioration of a function device arranged in a container, and the like. In particular, a laser beam has been known as a means of local heating.

United States Patent Application Publication No. US2006/0082298 discloses a manufacturing method of a container of an OLED. In this method, a frame member and a sealant (frit) are arranged in the circumferential edge portions of a first glass substrate and a second glass substrate arranged to face each other. Subsequently, a laser beam is irradiated along an extending direction of the sealant so that a certain temperature is substantially maintained in the sealant, thereby achieving hermetic sealing.

Japanese Patent Application Laid-Open No. 2008-059781 discloses a manufacturing method of a container of an FED or a PDP. In this method, a sealant is arranged on four sides between a first glass substrate and a second glass substrate arranged to face each other. Subsequently, a lease beam is irradiated to the sealant on each of the four sides to melt the sealants on the four sides together, thereby achieving hermetic sealing.

As just described, there have been conventionally known not only a sealing method whereby a laser beam is simply irradiated to the four sides but also a sealing method whereby a laser irradiation condition is changed and a sealing method whereby a laser irradiation route, laser irradiation order and the like are variously improved. However, as illustrated in FIG. 7B, when local heating light 58 is scanned along the sealant to obtain the hermetic container having continuous and closed sealing as illustrated in FIG. 7A, a problem of cracking occurs, whereby there is a case where airtightness and sealing reliability deteriorate. This is attributed to a fact that, when the local heating light 58 is used as illustrated in FIG. 7B, both a region (sealed portion) 56 to which the local heating light 58 was irradiated and a region (unsealed portion) 57 to which the local heating light 58 is not yet irradiated exist resultingly. Namely, it is considered that a local contraction difference occurs between the sealed portion 56 and the unsealed portion 57 in a process of cooling the sealed portion 56, and a crack caused by the contraction difference occurs in the glass substrate adjacent to of a boundary 55 between the sealed portion 56 and the unsealed portion 57. Incidentally, in FIG. 7A, the central plan view includes A-A, B-B, C-C and D-D lines, and the cross sectional views respectively along these lines are shown in the vicinity of the corresponding lines respectively. Further, in FIG. 7B, the plan view includes an E-E line, and the cross sectional view along this line is shown in the vicinity of this line.

The present invention aims to provide a manufacturing method of a highly-reliable hermetic container having both joining strength and airtightness.

### SUMMARY OF THE INVENTION

The present invention is directed to a manufacturing method of a hermetic container which has a first glass substrate and a second glass substrate which is sealed to the first glass substrate to form at least a part of the hermetic container together with the first glass substrate.

The manufacturing method in the present invention is characterized by comprising steps of: providing, between the first glass substrate and the second glass substrate, a sealant of which a viscosity has a negative temperature coefficient, of which a softening point is lower than that of each of the first glass substrate and the second glass substrate, which has a discontinuous portion, and which extends in a frame shape; and heating and melting the sealant to seal the first glass substrate and the second glass substrate to each other by, in a state of the sealant being pressed in a thickness direction thereof, irradiating local heating light to the sealant while scanning an irradiation region of the local heating light to the sealant along a direction in which the sealant extends in the frame shape, wherein the irradiation of the local heating light to the sealant is performed so as to form a continuous sealed portion between the first glass substrate and the second glass substrate by, after irradiating the local heating light to one region of two regions of the sealant facing each other across the discontinuous portion to heat and melt the one region, irradiating the local heating light to the other region of the sealant to heat and melt the other region and thus closing the discontinuous portion by the melted sealant.

According to the present invention, when the local heating light is irradiated to the sealant, a boundary between a region (sealed portion) to which the local heating light was irradiated and a region (unsealed portion) to which the local heating light is not yet irradiated is formed at the discontinuous portion formed on the sealant. Consequently, it is possible to avoid that a local contraction difference occurs in the sealant when irradiation of the local heating light is started from an arbitrary position on the sealant, whereby it is thus possible to reduce occurrence of a crack. Since the discontinuous portion can be closed up by heating and melting the sealant adjacent to the discontinuous portion, the continuous sealed portion is circumferentially formed between the glass substrates, whereby the highly-reliable hermetic container having both joining strength and airtightness can resultingly be obtained.

Further features of the present invention will become apparent from the following description of exemplary embodiments with reference to the attached drawings.

### BRIEF DESCRIPTION OF THE DRAWINGS

FIG. 1A is a plan view for describing an arrangement of sealants according to an embodiment of the present invention.

FIG. 1B is a cross sectional view for describing the arrangement of the sealants according to the embodiment of the present invention.

FIG. 1C is a cross sectional view for describing the arrangement of the sealants according to the embodiment of the present invention.

FIG. 1D is a cross sectional view for describing the arrangement of the sealants according to the embodiment of the present invention.

FIG. 2A is a plan view for describing an arrangement of the sealants according to another embodiment of the present invention.

FIG. 2B is a cross sectional view for describing the arrangement of the sealants according to another embodiment of the present invention.

FIG. 2C is a cross sectional view for describing the arrangement of the sealants according to another embodiment of the present invention.

FIG. 2D is a cross sectional view for describing the arrangement of the sealants according to another embodiment of the present invention.

FIG. 3A is a plan view illustrating the vicinity of the corner of a sealed portion formed on a glass substrate.

FIG. 3B is a plan view illustrating the vicinity of the corner of the sealed portion formed on the glass substrate.

FIG. 4A is a schematic plan view illustrating an example of a modification of a slit.

FIG. 4B is a schematic plan view illustrating an example of the modification of the slit.

FIG. 4C is a schematic plan view illustrating the example of the modification of the slit.

FIG. 4D is a schematic plan view illustrating the example of the modification of the slit.

FIG. 5A is a schematic plan view illustrating an example of a planar shape of the sealant.

FIG. 5B is a schematic plan view illustrating an example of the planar shape of the sealant.

FIG. 5C is a schematic plan view illustrating an example of the planar shape of the sealant.

FIG. 6 is a partially broken perspective view illustrating an FED to which a manufacturing method of a hermetic container according to the present invention is applicable.

FIG. 7A is a plan and cross sectional view for describing a state that the hermetic container is manufactured.

FIG. 7B is a plan and cross sectional view for describing a state that the hermetic container is manufactured.

### DESCRIPTION OF THE EMBODIMENTS

Hereinafter, embodiments of the present invention will be described in detail with reference to the accompanying drawings. A manufacturing method of a hermetic container according to the present invention can be applied to a manufacturing method of a container to be used for an FED, an OLED, a PDP or the like having a device of which the internal space is required to be hermetically cut off from an external atmosphere. Especially, in an image displaying apparatus such as the FED or the like of which the inside is set as an evacuated space, joining strength which can withstand an atmospheric pressure load generated due to a negative pressure of the internal space is required. Here, according to the manufacturing method of the hermetic container in the present invention, both securement of the joining strength and airtightness can highly be achieved. However, the manufacturing method of the hermetic container according to the present invention is not limited to the above-described manufacturing method of the hermetic container but can be widely applied to a manufacturing method of a hermetic container having sealed portions, which are required to have airtightness, on peripheral portions of the glass substrates facing each other.

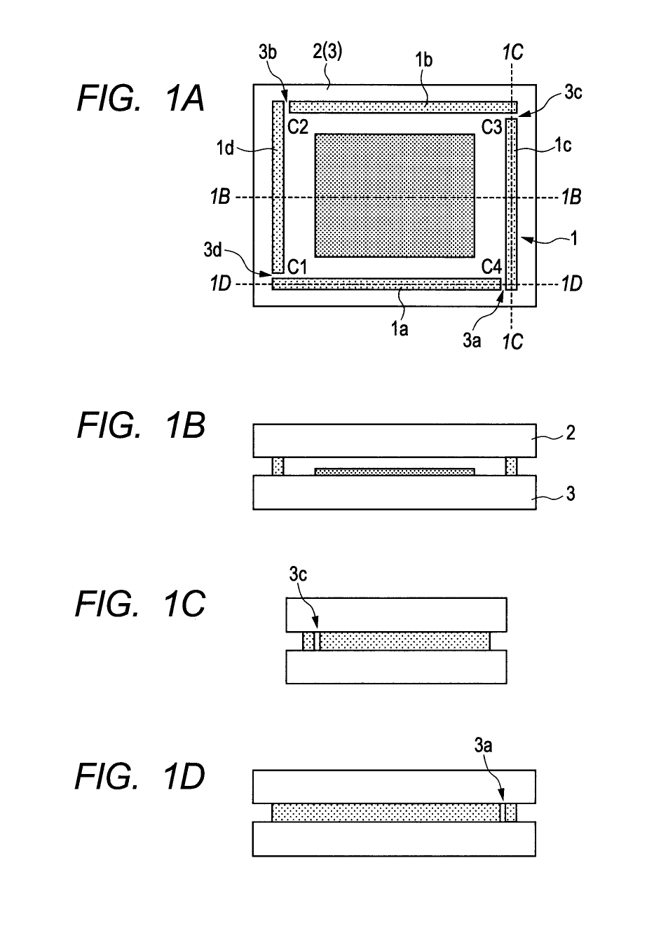

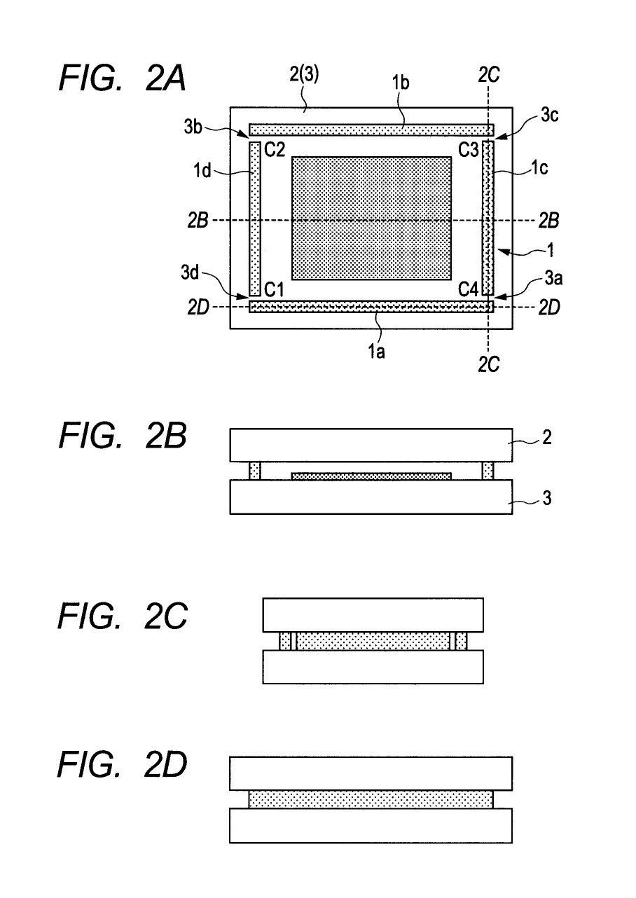

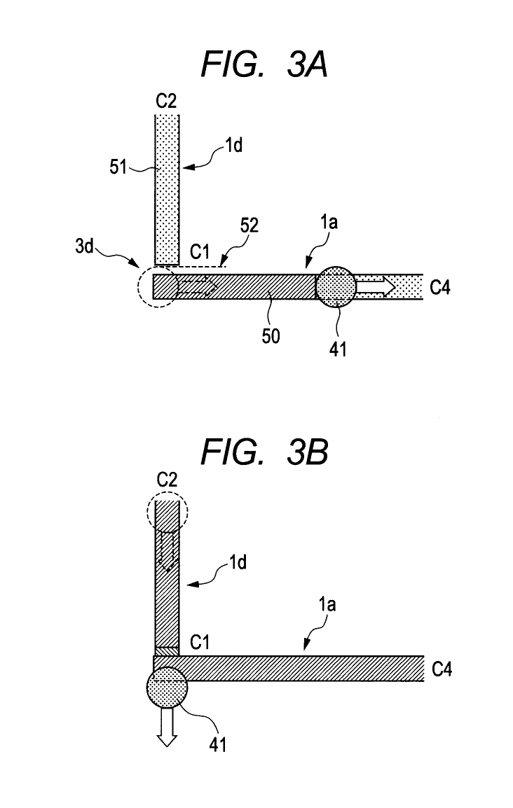

Initially, a method of sealing the glass substrates to each other in the manufacturing method of the hermetic container according to the present invention will be described with reference to FIGS. 1A, 1B, 1C, 1D, 2A, 2B, 2C, 2D, 3A and 3B. More specifically, FIGS. 1A to 1D are the plan and cross sectional views for describing an arrangement of the sealants according to an embodiment of the present invention. Here, FIG. 1B is the cross sectional view along a 1B-1B line in FIG. 1A, FIG. 1C is the cross sectional view along a 1C-1C line in FIG. 1A, and FIG. 1D is the cross sectional view along a 1D-1D line in FIG. 1A. FIGS. 2A to 2D are the plan and cross sectional views for describing an arrangement of the sealants according to another embodiment of the present invention. Here, FIG. 2B is the cross sectional view along a 2B-2B line in FIG. 2A, FIG. 2C is the cross sectional view along a 2C-2C line in FIG. 2A, and FIG. 2D is the cross sectional view along a 2D-2D line in FIG. 2A. FIGS. 3A and 3B are the plan views illustrating the vicinity of the corner of a sealed portion formed on the glass substrate.

In the two embodiments respectively illustrated in FIGS. 1A to 1D and FIGS. 2A to 2D respectively having the constitutions of the sealants, the embodiment illustrated in FIGS. 1A to 1D will mainly be described hereinafter.

(Step 1)

Initially, a first glass substrate 3 is prepared. As the first glass substrate, one glass substrate of a pair of the glass substrates constituting the hermetic container may be used. Further, a frame member which is positioned at the circumferential portion of the hermetic container and sandwiched between the pair of the glass substrates may be used. Furthermore, an integrated object which is constituted by integrating one of the pair of the glass substrates and the frame member to each other may be used.

Next, the sealant is provided between the pair of the glass substrates so as to have slit portions 3a, 3b, 3c and 3d serving as discontinuous portions and have a frame shape respectively at fourth, second, third and first corner portions C4, C2, C3 and C1, as illustrated in FIG. 1A.

More specifically, as illustrated in FIG. 1A, a frame-shape sealant 1 which is constituted by four linear sealants 1a, 1b, 1c and 1d is formed on the first glass substrate or the second glass substrate. As the sealant in the present invention, a sealant which is flowable at high temperature and rigid at low temperature is applicable. Namely, a sealant of which the viscosity has negative temperature dependency is applicable. Here, the sealant of which the viscosity has the negative temperature dependency includes a glass frit and an inorganic adhesive. Further, if the sealant applicable to the present invention has an absorbency which is higher than that of the glass substrate in regard to a wavelength of local heating light, it is desirable in the point of suppressing a heat stress to the glass substrate.

Next, the glass substrate on which the sealant 1 has been formed is temporarily baked. In this case, it should be noted that to temporarily bake the glass substrate corresponds to an operation that the glass substrate is heated at a temperature equal to or higher than a softening point of the sealant and equal to or lower than a temperature at which the sealant is not decomposed and crystallized. Subsequently, the one glass substrate (the first glass substrate 3 here) having the sealant 1 and the other glass substrate (a second glass substrate 2 here) are arranged to face each other, whereby an assembly body as illustrated in FIGS. 1B to 1D is formed.

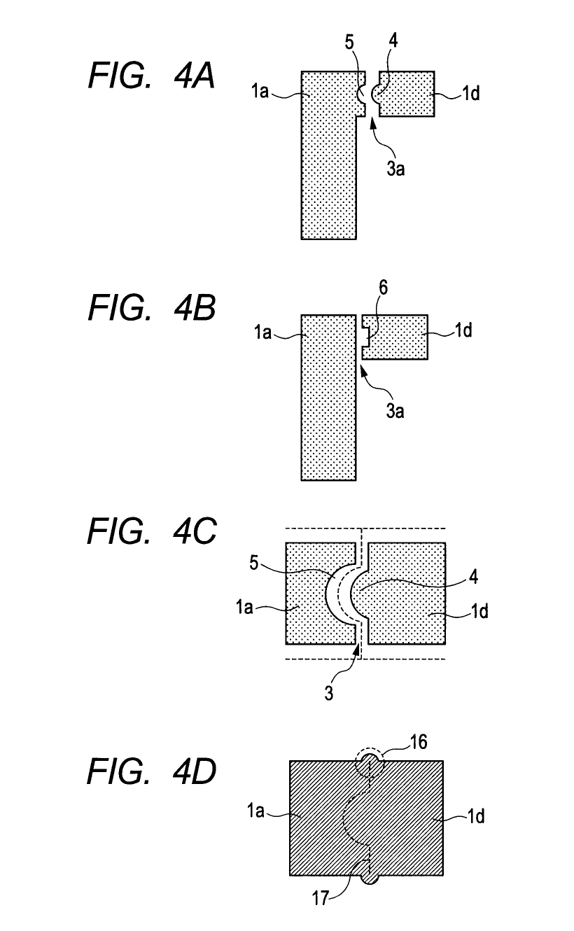

In the present embodiment, the shape of the slit portion serving as the discontinuous portion is a linear shape. However, the shape may be a curved shape as illustrated in FIG. 4A or another geometric shape as illustrated in FIG. 4B.

Further, the slit portions may be arranged as illustrated in FIG. 2A, 5A, 5B or 5C respectively. Furthermore, when an outline of the frame shape of the sealant is provided in a rectangle shape, the positions of the slit portions are not limited to those illustrated in FIG. 1A of arranging the discontinuous portions at the portions corresponding to respective vertexes of the rectangle shape. Furthermore, the number of the slit portions is not limited to four as illustrated in FIG. 1A. Namely, the number of the slit portions may be at least one or more.

(Step 2)

Subsequently, a load is applied to the assembly body by a not-illustrated pressurizing unit so as to compress the sealant 1 to its thickness direction (i.e., the direction in which the first glass substrate 3 and the second glass substrate 2 face each other). The pressure by the pressurizing means is directly applied to the first glass substrate 3 and/or the second glass substrate 2. Therefore, in other words, the step 2 is the step of pressing the first glass substrate 3 toward the second glass substrate 2 or pressing the second glass substrate 2 toward the first glass substrate 3.

The pressure is performed in a later-described step 3 to supplement driving force for absolutely protruding the sealant heated and melted by the irradiation of the local heating light into the slit portion being the discontinuous portion while maintaining the state that the first and second glass substrates are arranged to face each other. Incidentally, when the sealant can be pressed by the own weight of the glass substrate itself, any specific pressurizing unit is not necessary. Here, it should be noted that the pressurizing unit includes a mechanical unit of externally pressing the glass substrate through a weighting pin or the like, and an evacuating unit of pressing the glass substrate by using a pressure difference between the inside of the assembly body and an external space generated by evacuating the inside of the assembly body. Further, the pressurizing unit includes a positive pressure unit of pressing the glass substrate by disposing the assembly body within a pressure container and then setting the inside of the pressure container to positive pressure.

Incidentally, in the process of providing the sealant between the first glass substrate and the second glass substrate in the step 1, the glass substrate to which the sealant is formed does not have to be only either the first glass substrate or the second glass substrate. Namely, in case of providing the sealant between the first glass substrate and the second glass substrate, it is unnecessary to use only a method of, after forming the sealant on the first glass substrate or the second glass substrate, bringing the formed sealant into contact with the second glass substrate or the first glass substrate. For example, it is possible to use a method in which a region A and a region B which are adjacent to each other through a discontinuous portion when the first glass substrate and the second glass substrate are arranged to face each other are previously defined on the first glass substrate and the second glass substrate. More specifically, the region A is previously defined on the first glass substrate, and the region B is previously defined on the second glass substrate. Then, after the sealants were formed respectively on the region A and the region B, the first glass substrate and the second glass substrate are arranged to face each other.

(Step 3)

Subsequently, local heating light 41 is irradiated to each of the linear sealants 1a to 1d along the direction in which the sealant 1 extends in the frame shape, while maintaining the state that the sealant 1 is being pressed. In this case, the present invention can be carried out by performing a sequence of irradiation to the respective linear sealants 1a to 1d as described below.

The sequence of irradiation of the local heating light to the sealant 1 having the frame shape includes following sub-steps 3-1 to 3-5.

(Sub-step 3-1)

First, four light sources for generating the local heating light are prepared. Here, it should be noted that the irradiation start position of the local heating light to the linear sealant is set to, from the two ends of each of the linear sealants 1a to 1d, the one end which does not face the slit portion.

(Sub-step 3-2)

Hereinafter, the sequence of the irradiation of the local heating light will be described in detail by taking the sequence of scanning the linear sealant 1a, the slit portion 3a and a part of the linear sealant 1c as an example. The irradiation of the local heating light by the not-illustrated light source is started from the left 1D side illustrated in FIG. 1A, and then scanned toward the right 1D side. On this occasion, at a time when the left 1D side is irradiated, the linear sealant 1c on the right 1D side may not be irradiated yet by the local heating light. However, at least when the irradiation of the local heating light to the linear sealant 1a comes to the adjacent linear sealant 1c across the slit portion 3a, it is necessary to reach a stage that the linear sealant 1c was already irradiated by another heating unit (local heating light). In other words, it is necessary to reach a stage that the pair of the glass substrates were already sealed locally.

(Sub-step 3-3)

In the sequence of scanning the linear sealant 1b, the slit portion 3b and a part of the linear sealant 1d, as well as the sub-step 3-2, the irradiation start position of the local heating light is set to, from the two ends of the linear sealant 1b, the one end which does not face the slit portion. Then, the irradiation of the local heating light advances toward the slit portion 3b formed by the linear sealants 1b and 1d. On this occasion, at a time when the irradiation of the local heating light to the linear sealant 1b is started, the linear sealant 1d positioned on the irradiation end side of the local heating light may not be irradiated yet by the local heating light. However, at least when the irradiation of the local heating light to the linear sealant 1b comes to the adjacent linear sealant 1d across the slit portion 3b, it is necessary to reach a stage that the linear sealant 1d was already irradiated by another heating unit (local heating light). In other words, it is necessary to reach a stage that the pair of the glass substrates were already sealed locally.

(Sub-step 3-4)

In this sub-step, the local heating light is irradiated to the linear sealant 1d, the slit portion 3d and a part of the linear sealant 1a, as well as the above sub-steps.

(Sub-step 3-5)

In this sub-step, the local heating light is irradiated to the linear sealant 1c, the slit portion 3c and a part of the linear sealant 1b, as well as the above sub-steps.

Although the irradiations of the local heating light to the respective linear sealants can be started at the same time, the present invention is not limited to such timing. For example, when the hermetic container in which the length of each of the linear sealants 1a and 1b is set to 800 mm and the length of each of the linear sealants 1c and 1d is set to 450 mm is manufactured, irradiation speed (scanning speed) of the local heating light to all of the linear sealants 1a to 1d is set to 400 mm/sec. In this case, a time necessary for scanning the region of each of the relatively longer linear sealants 1a and 1b is 2 seconds, and a time necessary for scanning the region of each of the relatively shorter linear sealants 1c and 1d is 1.125 seconds. Therefore, in the embodiment of the present invention, in the sub-step 3-4, delay of the irradiation start time less than 2 seconds can be permitted in regard to the irradiation start time in the sub-step 3-3. Likewise, in the sub-step 3-5, delay of the irradiation start time less than 2 seconds can be permitted in regard to the irradiation start time in the sub-step 3-2. To the contrary, when the irradiation start time in the sub-step 3-4 precedes the irradiation start time in the sub-step 3-2, in the sub-step 3-2, delay of the irradiation start time less than 1.25 seconds can be likewise permitted in regard to the irradiation start time in the sub-step 3-4.

When focusing on the linear sealants 1a and 1d which together form the slit portion 3d, the above-described sub-steps 3-1 to 3-5 result in the following scanning. The relevant scanning will be described in detail with reference to FIGS. 3A and 3B.

Namely, the irradiation of the local heating light is started from the one end, in the two ends of the linear sealant 1a, which does not face the slit portion, and then the irradiation of the local heating light is scanned toward the other end of the linear sealant 1a. On another front, the irradiation of the local heating light is started from the not-illustrated one end, in the two ends of the linear sealant 1d, which does not face the slit portion, and then the irradiation of the local heating light is scanned toward the other end of the linear sealant 1d, that is, toward the end which faces the side surface of the linear sealant 1a across the slit portion. Thus, as illustrated in FIG. 3B, the melt region of the sealant generated by the irradiation of the local heating light to the linear sealant 1d moves with the scanning of the local heating light. Then, a part of the melted sealant protrudes in the slit portion 3d at the end of the linear sealant 1d which faces the slit portion 3d, whereby the slit portion 3d is filled up with the sealant.

As described above, in consideration of the scanning speed of the local heating light and the length necessary for the scanning of the sealant, a temporal gap (or difference) between the irradiation start time of the local heating light to the linear sealant 1d and the irradiation start time of the local heating light to the linear sealant 1a is set to be within a predetermined range. Thus, it is possible to complete the sealing of all the sealants without the process that the sealed portion to which the local heating light was already irradiated and the unsealed portion to which the local heating light is not yet irradiated are directly adjacent to each other in the continuous sealants.

Incidentally, in the process that the local heating light is irradiated and scanned, the unsealed portion and the sealed portion exist respectively before and after the irradiation region moving in the scanning direction. However, since the sealant has been softened and melted in the irradiation region of the local heating light, a tensile stress caused by cooled contraction of the sealed portion is not generated between the sealed portion and the unsealed portion. Therefore, it should be noted that the sealed portion and the unsealed portion which are adjacent to each other across the irradiation region do not become an occurrence factor of a crack being the problem to be solved by the present invention. Consequently, in the present invention, the above state “the sealed portion to which the local heating light was already irradiated and the unsealed portion to which the local heating light is not yet irradiated are directly adjacent to each other in the continuous sealants” includes the state that the sealed portion and the unsealed portion are adjacent to each other without the irradiation region.

The local heating light only has to be able to locally heat the vicinity of the sealing region, and a semiconductor laser is preferably used. More specifically, a processing semiconductor laser having a wavelength in an infrared region is preferable in terms of performance of locally heating the frame-shape sealant 1, permeability of each of the glass substrates 2 and 3, and the like. As a condition of irradiating the local heating light 41, it is preferable to select the local heating light so that a softening volume of the sealant per unit time increases, in the point of obtaining a protruding amount of the sealant enabling to absolutely close up the discontinuous portion. For this reason, when it is assumed that the beam diameter of the laser in the scanning direction is φS, the scanning speed is v, and the density of the laser beam intensity is I, then it is possible, by defining a value of I·φS/v, to secure the sufficient protruding amount of the sealant.

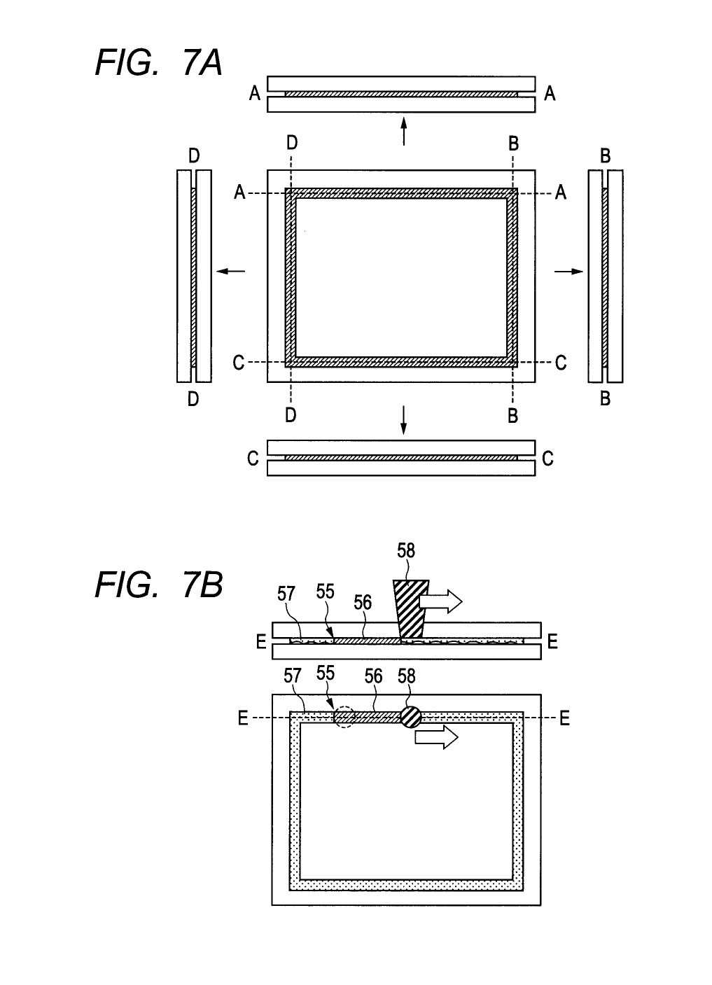

As described above, since the viscosity of the sealant has the negative temperature coefficient, the viscosity is once lowered and thus the sealant is fluidized when the sealant is heated and melted. However, when the irradiation of the local heating light ends, the viscosity again increases, and the state of the sealant returns to that in the room temperature. Therefore, in the sealant which is formed in the continuous frame shape as illustrated in FIGS. 7A and 7B, a contraction difference occurs between the sealed portion 56 to which the local heating light 58 was irradiated and the unsealed potion 57 to which the local heating light 58 is not yet irradiated, while the viscosity of the sealant increases, that is, while the sealant is cooled. In the process that the state of the sealed portion 56 returns to that in the room temperature, the contraction difference between the sealed portion 56 and the unsealed portion 57 increases, and a residual stress at the boundary 55 between the sealed portion 56 and the unsealed portion 57 increases. Thus, in the glass substrate, a crack occurs in the vicinity of the boundary 55.

However, in the present embodiment, the irradiation of the local heating light is performed so that the boundary, between the sealed portion and the unsealed portion, at which the contraction difference can occur does not exist within the range of the continuous sealant, as described above. Further, in the slit portion which is provided within the range of the scanning path of the frame-shape sealant, the irradiation of the local heating light is performed so that the protruding portion of the softened sealant closes up the slit portion. For example, as illustrated in FIG. 3A, when the local heating light 41 is irradiated to the linear sealant 1a between the first corner portion C1 and the fourth corner portion C4, a (virtual) boundary 52 between a sealed portion 50 and a unsealed portion 51 is positioned in the slit portion 3d. Thus, it is possible to avoid occurrence of the local contraction difference of the sealant even when the local heating light is irradiated. Thus, it is possible to suppress the above-described occurrence of the crack.

Incidentally, it is possible to increase the protruding amount of the sealant in the scanning direction of the local heating light, by increasing the inner pressure of the sealant when the local heating light is irradiated.

Before the local heating light is irradiated, the first and second glass substrates 2 and 3 are temporarily adhered to each other to suppress an expansion of the space therebetween caused by respective warps of the glass substrates 2 and 3, thereby minimizing a pressure loss. It should be note that such an operation is included in the present invention from the viewpoint of maintaining pressure of the melted and softened sealant.

For example, although the sealant made of the glass frit is thermally expanded by heat, there is a case where it is difficult to close up the slit portion only by an effect of such thermal expansion. Consequently, in order to effectively increase the protruding amount of the sealant in the heating, it is necessary to irradiate the local heating light to the sealant in the state that pressing force is being added to the sealant. The sealant includes the three regions, that is, the hardened region to which the sealing has already been completed, the hardened region to which the sealing is not performed, and the softened region to which the local heating light is being irradiated. Here, in the pressure to the sealant, it is specifically preferable to selectively press the softened region to which the irradiation is being performed. This is because, when the sealant is pressed through the substrate to be sealed, the pressure to the two hardened regions is dispersed, whereby it is possible to control an influence of suppressing the pressure to the irradiation region.

The width and the shape of the slit portion to be formed in the sealant can properly be changed according to the substance and the film thickness of the sealant, and the irradiation range and the scanning speed of the local heating light, so that the slit portion can more absolutely be closed up.

Further, it is preferable to set the width of the slit portion (the distance between the sealants adjacent to each other across the discontinuous portion) to be several times or less the film thickness of the sealant. Thus, it is possible to obtain a continuous film thickness distribution between the regions in which the slit portion and the sealants are previously arranged.

On the other hand, when the width of the slit portion is too narrow, there is a case where the sealant on the opposite side across the slit portion is heated together with the sealant to be originally heated, and thus a melted history occurs in the sealant on the opposite side because of heat conduction and alignment of the irradiation range of the local heating light. Thus, it is preferable to secure, as the width of the slit portion, the width of 0.5 times or more the film thickness of the sealant.

Further, the slit portion does not necessarily have the linear shape as illustrated in FIGS. 1A to 3B. For example, the slit portion may have each of shapes as illustrated in FIGS. 4A and 4B respectively. Namely, FIGS. 4A and 4B are the schematic plan views illustrating examples of the modified constitution of the slit portion. Further, FIG. 4C is an enlarged view illustrating the slit portion illustrated in FIG. 4A, and FIG. 4D is a schematic plan view illustrating the sealant having the constitution illustrated in FIG. 4C after the state that the local heating light was irradiated to the slit portion.

In the example illustrated in FIG. 4A, a convex portion 4 protruding in the slit portion 3a is provided at the end, facing the slit portion 3a, of the one linear sealant 1d of the two linear sealants 1a and 1d facing each other across the slit potion 3a. Further, a concave portion 5 corresponding to the convex portion 4 is provided at the end, facing the slit portion 3a, of the other linear sealant 1a. When the local heating light is irradiated to the linear sealants 1a and 1d having such a constitution, the linear sealants 1a and 1d protrude so that the convex portion 4 and the concave portion 5 are engaged with each other as illustrated by the dotted lines in FIG. 4C, whereby it is possible to further absolutely close up the slit portion 3a. At this time, when the protruding amount of the sealant is larger than the width of the slit portion, flash portions 16 are formed at both the ends of a join 17 formed between the linear sealants 1a and 1d as illustrated in FIG. 4D. On the other hand, in the example illustrated in FIG. 4B, a concave portion 6 is provided on the end, facing the slit portion 3a, of only the one linear sealant 1d of the two linear sealants 1a and 1d facing each other across the slit portion 3a. In this case, since the concave portion 6 is formed in the vicinity of the center, in the width direction, of the linear sealant 1d by which the protruding amount of the sealant is largest, it is possible to cause the sealant to uniformly protrude entirely in the slit portion 3a. Consequently, as well as the case illustrated in FIG. 4A, it is possible to more absolutely close up the slit portion 3a by the linear sealants 1a and 1d.

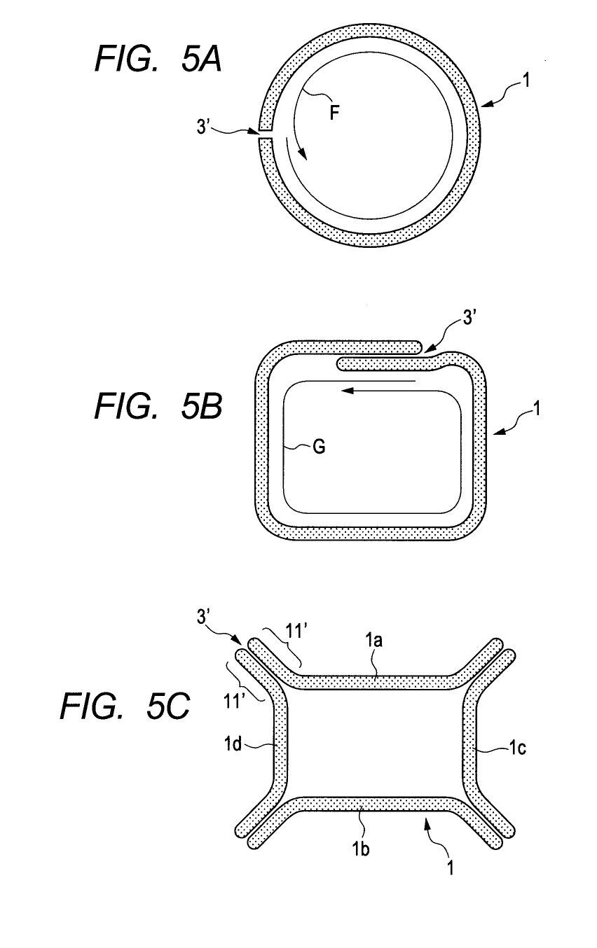

In the present embodiment, the whole sealant, which consists of the four linear sealants, has the rectangular shape in which the four slit portions each formed between the adjacent linear sealants are provided. However, the present invention is not limited to this shape. For example, the sealant has such a shape as illustrated in each of FIGS. 5A to 5C. FIGS. 5A to 5C are the schematic plan views illustrating modified examples of the planar shape of the sealant formed in the frame shape.

In the example illustrated in FIG. 5A, the sealant 1 is formed to have an annular shape so that both the ends thereof face each other across a slit portion 3′ and the respective ends extend in the direction crossing the slit portion 3′. In this case, the irradiation of the local heating light is started from the one end (irradiation leading end) of the sealant 1 adjacent to the slit portion 3′, and then advanced to the other end (irradiation trailing end) along the annular shape of the sealant 1 (as indicated by an arrow F in the drawing). Then, the local heating light is irradiated to the sealant 1 so as to cross the slit portion 3′, and the portion of the sealant 1 adjacent to the slit portion 3′ protrudes into the slit portion 3′ to close up the slit portion 3′, whereby the continuous sealing portion is formed.

In the constitutions as illustrated in FIGS. 1A to 1D, 2A to 2D, and 5A, to be able to irradiate the local heating light to the sealant across the slit portion, the sealant is formed so that at least one of the two regions facing each other across the slit portion extends across the slit portion. However, as illustrated in FIGS. 5B and 5C, the sealant may be formed so that the two regions facing each other across the slit portion respectively extend in parallel with the slit portion.

In the example illustrated in FIG. 5B, the sealant 1 is formed in a rectangular annular shape in which the two ends of the sealant are arranged to be parallel with each other across the slit portion 3′. In this case, the irradiation of the local heating light is started from the one end (irradiation leading end) of the sealant 1, and then advanced to the other end (irradiation trailing end) along the rectangular annular shape of the sealant 1 (as indicated by an arrow G in the drawing). For this reason, the respective corner portions of the sealant 1 for coupling the adjacent linear portions together are formed in an arc shape so that the local heating light can be scanned along the sealant 1. Incidentally, as described above, the protruding amount of the sealant into the slit portion in the case where the local heating light is irradiated along the sealant arranged in parallel with the slit portion is relatively small as compared with a case where the local heating light is irradiated along the sealant arranged not in parallel with the slit portion. Consequently, after the local heating light was irradiated from the irradiation leading end to the irradiation trailing end of the sealant 1, the local heating light is again irradiated to the both side portions of the sealant, which are positioned close to each other across the slit portion 3′ along the slit portion 3′. Thus, since the sealants protrude from the both side portions into the slit portion, it is possible to more absolutely close up the slit portion 3′.

In the example illustrated in FIG. 5C, the sealant, which consists of the four linear sealants 1a to 1d, is formed in a rectangular shape which has coupling portions 11′ extending on a slant from both the ends of each of the linear sealants 1a to 1d. Further, the slit portion 3′ is formed between the coupling portions 11′ of the adjacent linear sealants. In this case, as well as the example illustrated in FIG. 5B, after the local heating light was irradiated along each of the linear sealants 1a to 1d, the local heating light is again irradiated to the both side portions having the slit portion 3′ therebetween, along the slit portion 3′.

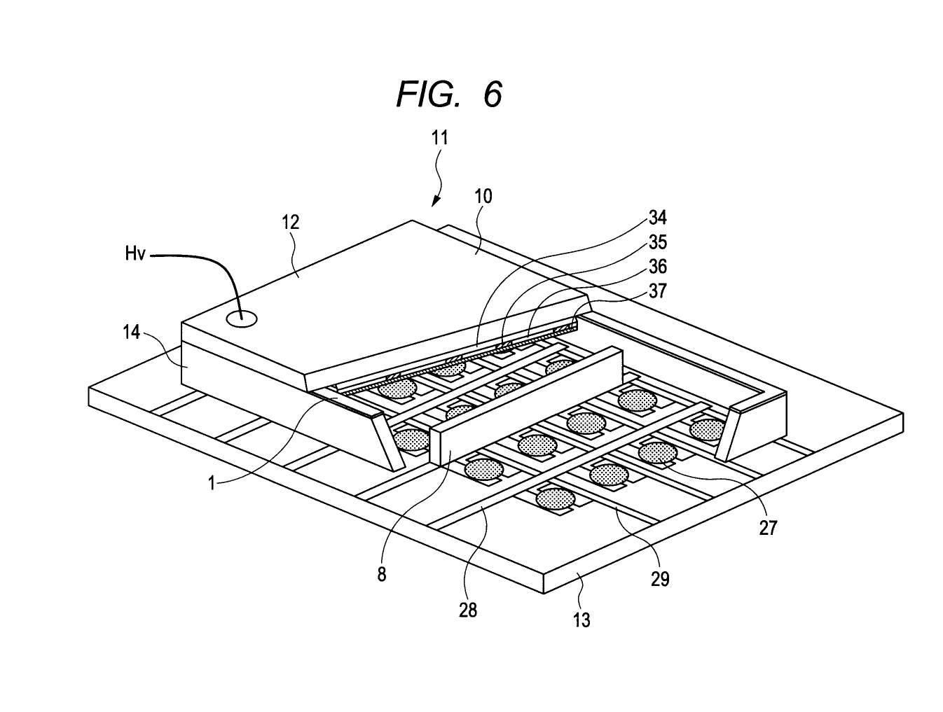

Subsequently, an image displaying apparatus which is manufactured by the above-described manufacturing method of the hermetic container will be described. FIG. 6 is a partially broken perspective view illustrating an example of the image displaying apparatus to which the present invention is applied. A container (hermetic container) 10 of an image displaying apparatus 11 has a face plate 12, a rear plate 13 and a frame member 14, which are all made of glass. The frame member 14, which is positioned between the face plate 12 and the rear plate 13 having plate shapes respectively, forms a hermetic space between the face plate and the rear plate 13. More specifically, the face plate 12 and the frame member 14, and the rear plate 13 and the frame member 14 are respectively sealed with each other by the planes which face each other, thereby forming the container 10 having a hermetically-sealed internal space. The internal space of the container 10 is maintained to be a vacuum state, and spacers 8 serving as a spacing distance defining member set between the face plate 12 and the rear plate 13 are provided at a predetermined pitch. The face plate 12 and the frame member 14, or the rear plate 13 and the frame member 14 may be previously sealed to each other or may be integrally formed.

A large number of electron-emitting devices 27 for emitting electrons in response to an image signal are provided on the rear plate 13, and matrix wirings for driving (X-directional wirings 28 and Y-directional wirings 29) for operating each of the electron-emitting devices 27 in response to the image signal are formed. A phosphor film 34 composed of phosphor for emitting light and displaying an image upon receiving the irradiation of electrons emitted from the electron-emitting devices 27 is provided on the face plate 12 positioned to face the rear plate 13. A black stripe 35 is further provided on the face plate 12. The phosphor films 34 and the black stripes are provided with a state that those are alternately arranged. A metal back 36 composed of a thin Al film is formed on the phosphor film 34. The metal back 36, which has a function of serving as an electrode for attracting electrons, receives potential supplied from a high-voltage terminal Hv provided on the container 10. A non-evaporable getter 37 composed of a thin Ti film is formed on the metal back 36.

Since it is sufficient that the face plate 12, the rear plate 13 and the frame member 14 are transparent and have translucency, soda lime glass, high strain point glass, non-alkaline glass or the like can be used for them. It is desirable that these glass members have excellent wavelength translucency in a used wavelength of local heating light and an absorption wavelength region of a sealant to be described later.

Incidentally, the container 10 of the image displaying apparatus 11 is manufactured as indicated below. Initially, the frame member (first glass substrate) 14 and the rear plate (second glass substrate) 13 are sealed with each other according to the above-described steps 1 to 3. Further, the face plate (first glass substrate) 12 and the frame member (second glass substrate) 14 are likewise sealed with each other according to the above-described steps 1 to 3. Thus, the container 10 in which the frame member 14 is inserted between the face plate 12 and the rear plate 13 is manufactured. Here, in the present invention, it should be noted that the first glass substrate means the substrate to which the sealant is formed and the second glass substrate means the substrate which is disposed to face the first glass substrate, whereby the concrete material that the first or second glass substrate means is different from others, depending on a situation.

In more general, the present invention is to provide the manufacturing method of the hermetic container at least a part of which consists of the rear plate 13 and the face plate 12. Therefore, the container 10 can also be manufactured in such a manner that the glass substrate to which the protruding portion having the shape of the frame member 14 is integrally formed in advance is used as one of the rear plate 13 and the face plate 12 and the relevant glass substrate is sealed to the other of the rear plate 13 and the face plate 12. Moreover, the container can also be manufactured in such a manner that the face plate 12 and the frame member 14 are precedently sealed to each other and the read plate 13 and the frame member 14 are then sealed to each other.

Further, although the present embodiment is directed to the image displaying apparatus, the present invention can more generally be applied to the sealing between the first glass substrate and the second glass substrate. In this case, the local heating light may be irradiated from either the first glass substrate side or the second glass substrate side.

Hereinafter, concrete examples of the above-described embodiment will be described in detail.

### EXAMPLE 1

The above-described manufacturing method of the heretic container is applied to this example. Namely, the rear plate (first glass substrate) having the frame member and the electron-emitting devices is sealed to the face plate (second glass substrate), and the evacuation hole is sealed by the cover member while evacuating the internal space through the evacuation hole. Thus, the vacuum hermetic container which is applicable as the container for the FED is manufactured.

(Step 1)

Initially, the first glass substrate 3 made by the high strain point glass substrate having the thickness 1.8 mm (PD200: made by Asahi Glass Co., Ltd.) was prepared. In this case, the matrix driving wirings were previously formed on the first glass substrate 3. Next, the not-illustrated frame member having the cross sectional height 1.5 mm and the cross sectional width 4 mm made by the PD 200 was sealed to the peripheral portion of the first glass substrate 3. Here, the frame member and the first glass substrate 3 were sealed to each other by temporarily baking and then really baking the screen-printed glass frit in the atmospheric firing furnace. Subsequently, the electron-emitting devices were formed at the respective matrix crossings of the matrix driving wirings. Thus, the first glass substrate 3 having the electron-emitting devices, the matrix driving wirings and the frame member was prepared.

Next, as illustrated in FIG. 1A, the sealant 1 was formed on the not-illustrated frame member provided on the first glass substrate 3. In this example, the glass frit was formed on the frame member in the screen printing by temporarily baking the glass frit at 460° C. for 30 minutes, and then the rectangular sealant consisting of the four linear sealants 1a to 1d each having the width 1 mm and the thickness 10 μm was formed. Further, the slit portions 3a to 3d each having the width 50 μm were formed respectively between the adjacent linear sealants (see FIG. 1D). The film thickness of the sealant 1 after the temporary baking was set to have absorbance “1” for the laser beam having the wavelength 980 nm, that is, to obtain 90% absorption.

Further, the length of each of the relatively longer linear sealants 1a and 1b was set to 800 mm, and the length of each of the relatively shorter linear sealants 1c and 1d was set to 450 mm.

(Step 2)

Subsequently, the first glass substrate 3 having the not-illustrated frame member and the second glass substrate 2 made of the high strain point glass substrate (PD200) having the thickness 1.8 mm were arranged to face each other while aligning them so that the glass substrates were in contact with each other through the sealant 1 (see FIGS. 1B to 1D). At this time, the sealant 1 was pressed by the load of about 60 kPa. Incidentally, a not-illustrated anode made by phosphor, a black matrix and Al was formed on the second glass substrate 2 prior to the process of the step 2. Here, the phosphor arrangement was set be equivalent to the pixel arrangement corresponding to the arrangement of the electron-emitting devices on the first glass substrate 3.

(Step 3)

Subsequently, the laser was irradiated to the assembly body including the first glass substrate 3 having the not-illustrated frame member, the sealant 1 and the second glass substrate 2. The method of irradiating the laser will be described hereinafter.

As the laser source, the not-illustrated two semiconductor laser heads provided on the not-illustrated breadboard to have the mural irradiation position interval 50 mm were used. The breadboard and the assembly body were arranged so as to perform the irradiation to the sealant while causing the one local heating light to follow the other local heating light by relatively moving the breadboard in regard to the sealant in the direction being in parallel with the arrangement direction of the two beam irradiation spots. The irradiation conditions of the two laser heads arranged on the breadboard were as follows. That is, the laser (first local heating light) from the laser precedently performing the irradiation to the sealant was the laser having the wavelength 980 nm, the laser power 212 W and the effective diameter 2 mm, and was scanned at speed 1000 mm/s. On the other hand, the laser head subsequently performing the irradiation to the sealant was disposed after the laser head precedently performing the irradiation by 0.05 seconds, that is, by the distance 50 mm as the irradiation spot in the scanning direction, and such an interval was maintained during the scanning. At that time, the laser (second local heating light) from the laser head subsequently performing the irradiation was set to the laser having the wavelength 980 nm, the laser power 212 W and the effective diameter 2 mm. Further, as the laser power of the local heating light 41, the laser power previously adjusted to set the temperature of the sealant 1 heated by the irradiation of the local heating light 41 to 700° C. was used.

The four sets of the laser sources arranged on the breadboard were prepared. Then, the end of each of the linear sealants 1a to 1d illustrated in FIG. 1A not facing the slit portion was set as the irradiation start position of each linear sealant, and each of the prepared four sets of the laser sources was scanned at the speed 1000 m/sec toward the other end of each of the linear sealants 1a to 1d. Hereinafter, the irradiation to the one linear sealant 1a will be described as an example. The irradiation of the laser to the linear sealant 1a was started from the left 1D side illustrated in FIG. 1A, and then scanned toward the right 1D side. The irradiations of the laser to the remaining linear sealants 1b to 1d were performed as well as the irradiation to the linear sealant 1a. Further, the irradiations of the lasers to the respective linear sealants were started simultaneously. Thus, the step of irradiating counterclockwise the laser to the four sides of the rectangular sealant 1 was completed. When the sealant 1 to which the laser irradiation step had been completed was observed, it was confirmed that the regions of the slit portions 3a, 3b, 3c and 3d had been closed up respectively by the sealants protruded from the ends of the linear sealants 1a, 1b, 1c and 1d, and that the frame member on the first glass member 3 and the second glass substrate 2 had been satisfactorily sealed to each other.

Here, the effective diameter of the laser was set to the beam irradiation range indicating the intensity of e⁻² (e is a natural logarithm) times the peak intensity.

As just described, the respective slit portions 3a to 3d were closed up by the sealant, and the continuous sealed portion was formed between the frame member on the first glass substrate 3 and the second glass substrate 2, whereby the hermetic container was manufactured. Next, the obtained hermetic container was evacuated, and the container of the FED was manufactured. When the obtained FED was operated, it was confirmed that the FED could stably emit electrons and display images for a long time, and it was thus confirmed that the obtained container had the airtightness and the intensity of which the levels were suitable for the FED.

### EXAMPLE 2

In the example 2, the sealants 1a to 1d were formed in the shape illustrated in FIG. 5C. In this example, the width of the slit portion 3 was set to 30 μm and the length of the coupling portion 11 was set to 1 mm. Then, the sealant was heated and melted using the galvano-method laser as the local heating light, while changing the scanning track of the local heating light in conformity with the shape of the sealant. The irradiation of the local heating light was performed at the scanning speed 500 mm/sec. The local heating light was irradiated to the sealants 1a to 1d with the output of setting the temperature in the vicinity of the center of each of the sealants 1a to 1d in the width direction to 700° C. Other operations in this example were the same as those in the example 1. The hermetic container was manufactured as described above. Next, the obtained hermetic container was evacuated, whereby the container of the FED was obtained. When the obtained FED was operated, it was confirmed that the FED could stably emit electrons and display images for a long time and the obtained container had the airtightness and the intensity of which the levels were suitable for the FED.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-144893, filed Jun. 25, 2010, which is hereby incorporated by reference herein in its entirety.

What is claimed is:

1. A manufacturing method of a hermetic container which has a first glass substrate and a second glass substrate which is sealed to the first glass substrate to form at least a part of the hermetic container together with the first glass substrate, the method comprising:
providing, between the first glass substrate and the second glass substrate, a sealant of which a viscosity has a negative temperature coefficient, of which a softening point is lower than that of each of the first glass substrate and the second glass substrate, which has a discontinuous portion, and which extends in a frame shape; and
heating and melting the sealant to seal the first glass substrate and the second glass substrate to each other by, in a state of the sealant being pressed in a thickness direction thereof, irradiating local heating light to the sealant while scanning an irradiation region of the local heating light to the sealant along a direction in which the sealant extends in the frame shape,
wherein the irradiation of the local heating light to the sealant is performed so as to form a continuous sealed portion between the first glass substrate and the second glass substrate by, after irradiating the local heating light to one region of two regions of the sealant facing each other across the discontinuous portion to heat and melt the one region, irradiating the local heating light to the other region of the sealant to heat and melt the other region and thus closing the discontinuous portion by the melted sealant.

2. The manufacturing method according to claim 1, wherein the irradiation of the local heating light to the sealant is started from the one region of the sealant, and then the local heating light is scanned in a direction away from the discontinuous portion.

3. The manufacturing method according to claim 1, wherein, after the local heating light was irradiated to the one region of the sealant, the local heating light crosses the discontinuous portion, and then the local heating light is scanned to be irradiated to the other region of the sealant.

4. The manufacturing method according to claim 1, wherein
an end of the one region of the sealant fronting the discontinuous portion has a convex portion protruding toward the discontinuous portion, and
an end of the other region of the sealant fronting the discontinuous portion has a concave portion corresponding to the convex portion.

5. The manufacturing method according to claim 1, wherein
the frame shape is a rectangle, and
the discontinuous portion is positioned at a portion corresponding to a vertex of the rectangle.

6. A manufacturing method of an image displaying apparatus which has a hermetic container, wherein the hermetic container is manufactured by the manufacturing method described in claim 1.
